(19) United States
(12) Patent Application Publication
(10) Pub. No.: US 2009/0078719 A1
(43) Pub. Date: Mar. 26, 2009

(54) Distributor Device for Solid Products

(76) Inventor: Roberto Guglielmi, Schio (Vicenza) (IT)

Correspondence Address: BUCKNAM AND ARCHER, 1077 NORTHERN BOULEVARD, ROSLYN, NY, 11576, US

(21) Appl. No.: 12/226,849

(22) PCT Filed: Jun. 11, 2007
(86) PCT No.: PCT/EP2007/005136

§ 371 Date: Oct. 30, 2008

(30) Foreign Application Priority Data
Jun. 26, 2006 (IT) VI2006A000194

(51) Int. Cl. G07F 11/42

(52) U.S. Cl. 221/224; 221/260

(57) ABSTRACT

Distributor device for solid products for individual use or for incorporation in automatic vending machines, wherein the products (P) are arranged aligned and adjacent to form a stack. The distributor device has particular constructive concept which facilitates the extraction of single solid products from the stack, even when tightly packed, including when “reciprocally stuck together,” as well as when the products are particularly slim, as often occurs with CD and DVD packaging. The first product from the stack is separated by means of a sheet, which creates a thrust action against one of the surfaces of the first product, completely sliding the first product from the stack. The sheet is realized in a flexible material in such a manner that, when the sheet slides forward to separate the first product, the sheet assumes a curved configuration and while during the following return stage, the sheet reassumes its flat configuration.

The present finding relates to a distributor device for solid products to be used individually or for incorporation in automatic vending machines according to the general description in claim 1.

So-called “automatic vending machines” are now common practise for the public who can extract the desired product directly from the distributor.

Current technical art for automatic vending machines includes a variety of technologies involving both the construction and practical function.

In particular a common type of vending machine exists, comprising a plurality of revolving platforms divided into various compartments, which rotate around their own axis in order to be able to position the selected product opposite a small hatch which can be opened by the user for access into the distributor to extract the desired product.

Other vending machines involve the use of spirals that rotate around a horizontal or vertical axis, which, when rotated, convey the product positioned and retained by the coil configuration of said spiral, to an opening where it can be extracted by the user.

Other vending machines involve the use of a storage system composed of two shelves divided into container compartments of various sizes, inside which a device is activated to push the selected product out from the storage shelf so that it is sent to an opening where it can be extracted by the user. These and other types of vending machines of known type present a drawback in that they make distribution of slim parallelepiped-shaped products difficult.

From a practical viewpoint, the distribution of slim box-shaped products (products like CDs and DVDs, books, and various types of boxes, for example) based on normal rotating platform or spiral distributor systems creates problems caused by the fact that when these objects are stored in the distributor, as well as occupying a considerable amount of space (one object for each compartment of the rotating platform or one object for each coil of the spiral) they must also be positioned (horizontally or vertically or in any case on a slope) meaning that the user is not permitted easy and complete viewing of the product, as with CD and DVD distribution for example, where it is necessary for the user to have a complete vision of the front of the package where the most important information (Image and text) concerning the product is printed.

Once again from a practical point of view, the distribution of very slim boxed products is also a problem when using shelf systems because the products are stacked on the shelves in horizontal or vertical stacks, making it difficult for the user to extract individual products, partly because of the very reduced thickness of the product, and partly because the products tend to stick to one another because of the tightly packed stacking.

The aim of the present finding is to provide a distributor for solid products having a slim parallelepiped configuration, for individual use or for incorporation in an automatic vending machine, which does not possess any of the drawbacks present in similar devices in prior art.

More specifically, the aim of the present invention is to provide a distributing system wherein the front part of the product is totally and clearly visible to the user.

Even more specifically, the aim of the present invention is to provide a distributing system which is able to separate each packed product from the pile of reciprocally stacked products in a completely automatic manner.

Yet another aim of the invention is to provide a distributor for very slim solid products, which is able to operate with products of varying size and thickness.

A further aim of the present invention is to provide a distributing system for very slim solid products, which is easy to construct, requires no maintenance, is economical and compact in size.

These aims are achieved with a distributor comprising a basically box-like structure, inside which the products are contained, arranged in manner to form a stack in the direction of the product thickness, and maintained reciprocally stacked by means of a thrust element; said distributor is characterised in that the individual product is separated from the pile of stacked products for easy removal by means of a fine sheet which is pushed onto one of the slim surfaces, causing the first product in the stack to be slid away from the stack while the second and all remaining products are maintained in position.

The invention is also characterised in that the aforesaid sheet is produced in a flexible material (such as harmonic steel), and therefore during the stage wherein the sheet slides forward to separate a single product from the stack, it assumes a curved configuration in order to remain strong enough to sustain the thrust force without bending; during the following stage wherein it returns to its original position it assumes its flat configuration once more, so that it can be removed rapidly from the work zone, thus permitting the immediate positioning of the following product in the so-called work zone.

The concept of the invention will be made more apparent with the description of a possible embodiment, provided as a non limiting example, and with the help of the appended drawings wherein:

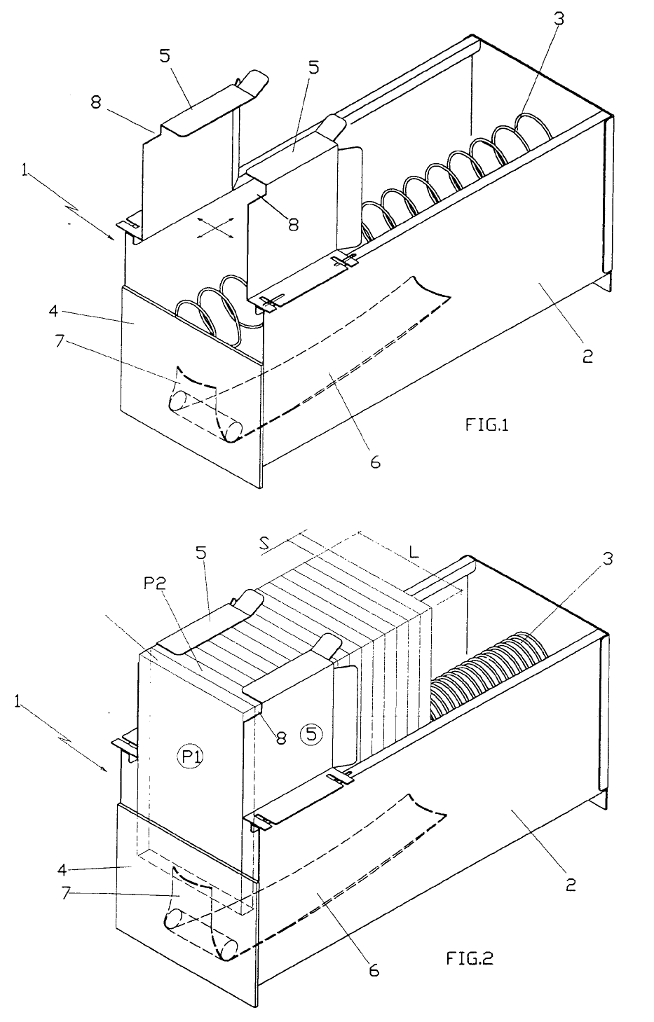

FIGS. 1-2 (plate I) show a view in perspective of the distributor according to the invention, in the two conditions, empty, and containing a stack of products, respectively;

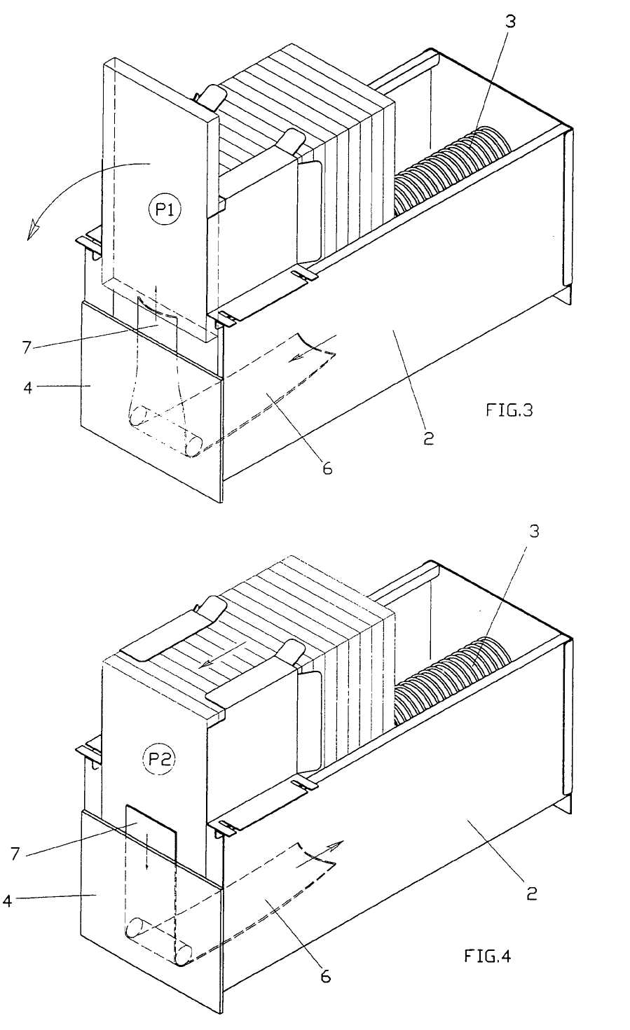

FIGS. 3-4 (Plate II) show a view in perspective of the distributor according to the invention, with the flexible sheet during the product thrust and return stages respectively;

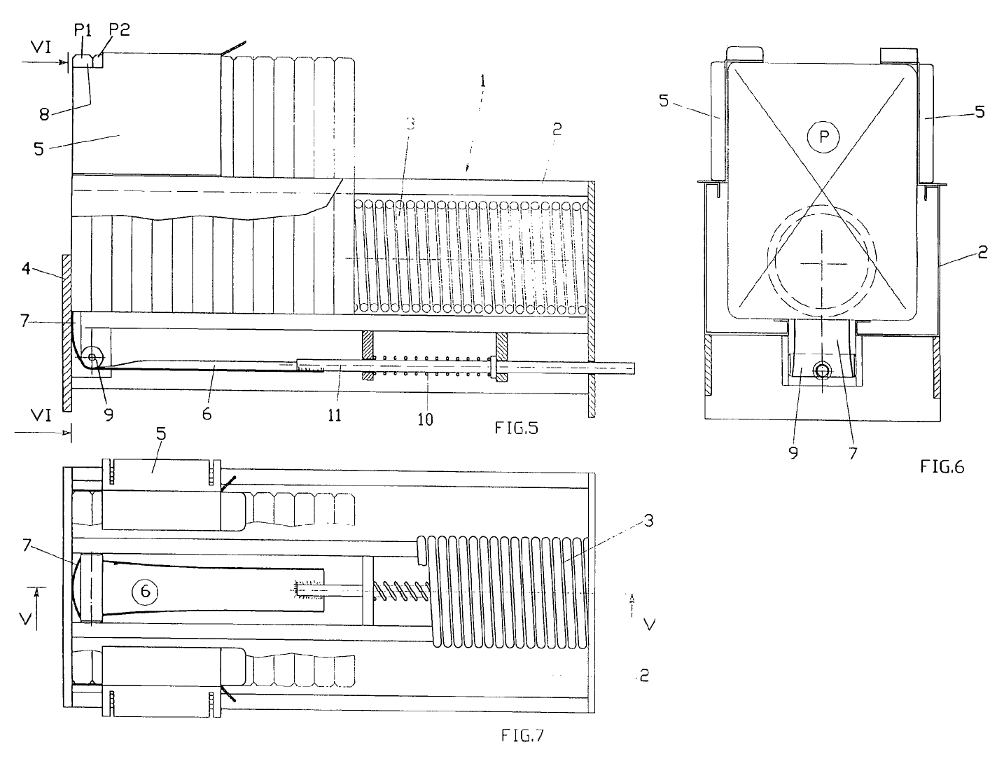

FIGS. 5-7 (plate III) show three orthogonal views, in partial cross section, of the distributor shown in FIG. 1;

FIGS. 8-10 (plate IV) show the different operational stages in sequence, of the distributor according to the invention.

FIGS. 1 and 2 shows how the distributor device according to the invention, identified throughout by the numeral 1, comprises a box-like case 2 inside which are contained the products “P”, piled in a stack, reciprocally adjacent to one another and maintained in the stacked position by means of a rear thrust action exercised by an elastic element 3 (such as a helical spring) which maintains the first product “P1” of the stack constantly in contact with the front wall 4 of said case.

The device 1 is completed with the presence of specifically shaped side ribs 5, applied on the upper part of the case 2, which act to contain and guide the stacked products “P”.

FIG. 2 shows how the single product “P1” is removed from the stack by means of the sheet 6 located under the stack, having a curved configuration, and terminating in an end portion 7, which moves to make contact with the thinnest side of the first product “P1”.

FIG. 3 shows how the product “P1” is removed by the forward sliding action (forward travel) of the sheet 6, that creates a thrusting force against the product which is consequently lifted until it rises completely over the front wall 4, flipping over by the force of gravity outside the distributor, where it is collected and moved to an accessible zone for extraction by the user.

After this operation, as can be seen in FIG. 4, the sheet 6 returns, and pushed by the thrust action of the elastic element 3, the whole stack moves forward until the product “P2” is in contact with the front wall 4. The invention provides for the use of a sheet 6 with two basic characteristics: good flexibility levels and a normally curved section.

FIG. 8 clearly shows how the curved section of the sheet (see detail) provides two operative advantages: it facilitates the thrust action against the product “P1”, since it has an effect on a reasonably large contact surface and prevents the terminal part 7 of the aforesaid sheet from bending because of the load on the tip.

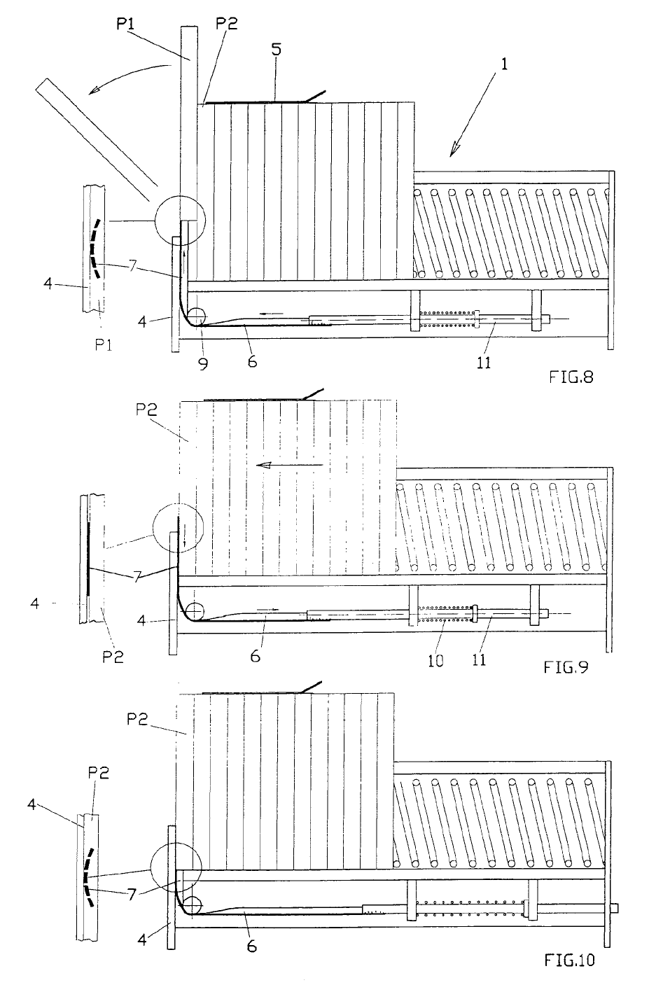

In the same way, FIG. 9 shows how the good flexibility capacity of the sheet 6 advantageously permits the terminal part 7 to modify its configuration from curved to flat, after the product “P1” has been unloaded, (see detail) moving into a flat position against wall 4 pushed by the second product “P2”, thus making it easier to return to its initial position and to permit the said product “P2” to be positioned in contact with the said wall 4 (see FIG. 10).

Another aspect conceived to prevent raising the successive product “P2” during the rising action of the first product “P1”, often accidentally stuck to one another (a situation that occurs frequently in stacks of CDs and DVDs where the plastic film wrappings often stick to each other) is provided by two side ribs 5 each being equipped with a slot 8 which is shaped in a manner so that the top of the first product “P1” remains completely uncovered, while the top of the second product “P2” is partially covered, and therefore is retained while the product in front of it is raised.(see FIG. 2).

In order to use the distributor 1 with products “P” of various widths “L” and thickness “S”, the invention provides for the connection of side ribs 5 to the case 2 in a moveable manner so that their position can be adjusted in both longitudinal and transversal directions (refer to the arrows in FIG. 1).

Lastly, the action of the sheet 6, which can possibly be wrapped around a return pin 9, can be performed manually using a counter spring 10 which brings the said sheet back to its most internal position, or automatically, with the application of an actuator on the pin 11 (the actuator can be of any common type and is not shown).

Naturally the embodiment can assume forms which may be considerably different from that described, according to the components employed, while remaining within the context of the invention as described in the following claims.

1. DISTRIBUTOR DEVICE FOR SOLID PRODUCTS, to be used individually or for incorporation in automatic vending machines, of the type where the products (P) are arranged aligned and adjacent to each other to form a stack, said distributor device being characterized in that each single product is separated from the pile of stacked products by means of a plate (6) which creates a thrust action against one of the surfaces of the said product, completely sliding the first of the stacked products (P1) from the pile, while the second product (P2) and successive products are retained, and said sheet (6) being realised in a flexible material in such a manner that during the operational stage, when the sheet slides forward to separate a single product from the stack, said sheet assumes a curved configuration, but remains sufficiently strong to sustain the thrust force without bending, while during the following return stage, the sheet reassumes its flat configuration permitting it to be slid from the work zone rapidly, and permitting the immediate positioning of the successive product in the said work zone.

2. DISTRIBUTOR DEVICE according to claim 1 comprising a box-like case (2) inside which are contained the products (P), arranged in a stack and reciprocally adjacent to each other, maintained stacked together by means of a thrust action exercised against the stack by an elastic element (3) which maintains the first product (P1) in the stack always in contact against the front wall (4) of said case, said device (1) being characterized in that the removal of the single product (P1) from the stack is performed by a sheet (6), positioned under the stack, and presenting a terminal portion (7) which makes contact with the thinnest side of the first product (P1), having a curved configuration, and by means of the forward sliding action (forward travel) it performs a thrusting action pushing against the product (P1) which is raised until it completely exceeds the front wall (4) and is flipped over by force of gravity outside the distributor.

3. DISTRIBUTOR DEVICE according to claim 2 characterized in that after the product (P1) has been unloaded, the terminal portion (7) of the sheet (6), pushed by the second product (P2) of the stack, modifies its section from a curved to a flat configuration, and flattens out against the wall (4) from where it slides out to return to its initial position, thus permitting the said product “P2” to be placed in contact with the said wall (4).

4. DISTRIBUTOR DEVICE according to claim 3 mounted with specifically shaped side ribs (5) applied to the upper part of the case (2) which act as a container and guide for the stacked products “P”, characterized in that the ribs (5) are each equipped with a slot (8) which is shaped in such a manner to leave the top of the first product (P1) completely uncovered, while covering the top part of the second product (P2), which remains retained while the front product is raised.

5. DISTRIBUTOR DEVICE according to claim 4 characterized in that the side ribs (5) are fixed to the case (2) in a movable manner, by mobile connecting means, and can be adjusted in both longitudinal and transversal directions in order to use the device (1) with products (P) having varying widths (L) and thickness (S).

6. DISTRIBUTOR DEVICE according to claim 3 characterized in that the motion of the flexible sheet (6) is activated manually using a counter spring (10).

7. DISTRIBUTOR DEVICE according to claim 6 characterized in that the motion of the flexible sheet (6) is activated automatically with the application of an actuator on a pin (11).
